(19) United States
(12) Patent Application Publication
(10) Pub. No.: US 2024/0168412 A1
(43) Pub. Date: May 23, 2024

(54) IMAGE FORMING APPARATUS

(71) Applicant: FUJIFILM Business Innovation Corp., Tokyo (JP)

(72) Inventors: Naoya NANRI, Kanagawa (JP); Arichika TANAKA, Kanagawa (JP); Yutaka KIUCHI, Kanagawa (JP); Go MIURA, Kanagawa (JP); Kenta TONOSU, Kanagawa (JP)

(73) Assignee: FUJIFILM Business Innovation Corp., Tokyo (JP)

(21) Appl. No.: 18/310,634

(22) Filed: May 2, 2023

(30) Foreign Application Priority Data
Nov. 18, 2022 (JP) 2022-185004

(51) Int. Cl. G03G 15/16

(52) U.S. Cl. CPC G03G 15/161

(57) ABSTRACT

An image forming apparatus includes plural image forming units configured to form respective toner images in different colors; an endless-shaped intermediate transfer member that is to move in a peripheral direction of the intermediate transfer member and to which the toner images are to be sequentially transferred from the plural image forming units; plural first-transfer units provided across from the respective image forming units and configured to transfer the toner images formed by the image forming units to the intermediate transfer member; a second-transfer unit provided on a downstream side relative to the plural first-transfer units in a direction of movement of the intermediate transfer member and configured to transfer the toner images on the intermediate transfer member to a medium; and a holding unit provided, in the direction of movement of the intermediate transfer member, between a downstreammost one of the first-transfer units and the second-transfer unit, the holding unit being configured to hold the intermediate transfer member from both sides of the intermediate transfer member.

### CROSS-REFERENCE TO RELATED APPLICATIONS

This application is based on and claims priority under 35 USC 119 from Japanese Patent Application No. 2022-185004 filed Nov. 18, 2022.

### BACKGROUND

### (i) Technical Field

The present disclosure relates to an image forming apparatus.

### (ii) Related Art

An image forming apparatus disclosed by Japanese Unexamined Patent Application Publication No. 2011-169950 includes an image carrier on an endless peripheral surface of which a latent image produced as an electrostatic potential difference is to be formed, a developing device configured to form a toner image by causing toner to adhere to the image carrier, an endless-shaped intermediate transfer belt stretched over a plurality of roll members and which receives the toner image in a first-transfer process by being in contact with the image carrier, a second-transfer device configured to transfer the toner image received by the intermediate transfer belt in the first-transfer process to a recording sheet, and an elastic member to be pressed against the inner peripheral surface of the intermediate transfer belt at a position in the direction of movement of the intermediate transfer belt that is between a first-transfer position where the first-transfer process for the toner image is to be performed and a second-transfer position where the intermediate transfer belt faces the second-transfer device.

### SUMMARY

Aspects of non-limiting embodiments of the present disclosure relate to an image forming apparatus that is less likely to cause nonuniformity in image density than in a case where an elastic member is pressed against only the inner peripheral surface of an intermediate transfer member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including a plurality of image forming units configured to form respective toner images in different colors; an endless-shaped intermediate transfer member that is to move in a peripheral direction of the intermediate transfer member and to which the toner images are to be sequentially transferred from the plurality of image forming units; a plurality of first-transfer units provided across from the respective image forming units and configured to transfer the toner images formed by the image forming units to the intermediate transfer member; a second-transfer unit provided on a downstream side relative to the plurality of first-transfer units in a direction of movement of the intermediate transfer member and configured to transfer the toner images on the intermediate transfer member to a medium; and a holding unit provided, in the direction of movement of the intermediate transfer member, between a downstreammost one of the first-transfer units and the second-transfer unit, the holding unit being configured to hold the intermediate transfer member from both sides of the intermediate transfer member.

### BRIEF DESCRIPTION OF THE DRAWINGS

An exemplary embodiment of the present disclosure will be described in detail based on the following figures, wherein:

FIG. 1 schematically illustrates an image forming apparatus according to an exemplary embodiment;

FIG. 2 is a perspective view of a transferring member included in the image forming apparatus according to the exemplary embodiment;

FIG. 3 is a perspective view of a fixing device included in the image forming apparatus according to the exemplary embodiment;

FIG. 4 illustrates toner-image-forming unit for black and a holding unit that are included in the image forming apparatus according to the exemplary embodiment;

FIG. 5 is a perspective view of the holding unit included in the image forming apparatus according to the exemplary embodiment; and

FIG. 6 is a side view of the holding unit included in the image forming apparatus according to the present exemplary embodiment.

### DETAILED DESCRIPTION

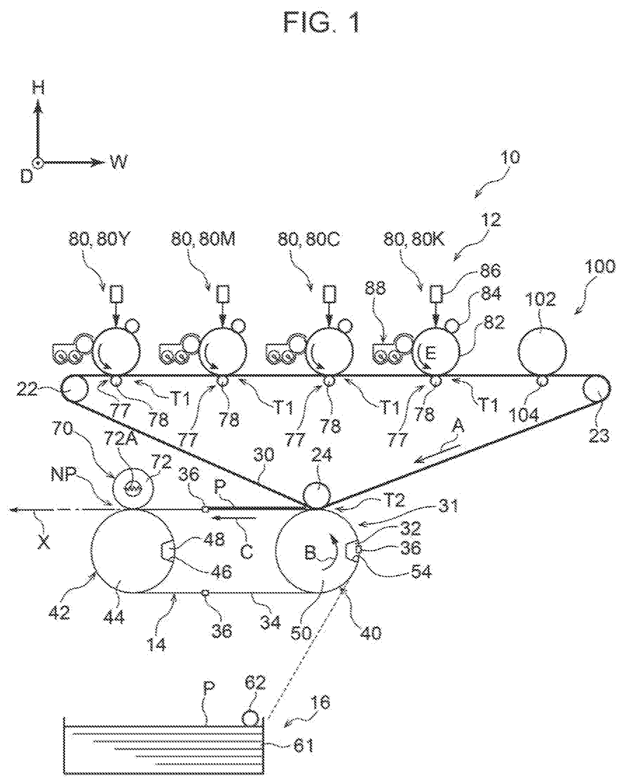

An exemplary embodiment of the present disclosure will now be described in detail with reference to the drawings. As a matter of convenience of description, referring to FIG. 1 and others, arrow H represents the top-bottom direction of an image forming apparatus 10, arrow W represents the width direction of the image forming apparatus 10, and arrow D represents the depth direction of the image forming apparatus 10.

### Exemplary Embodiment

FIG. 1 schematically illustrates the image forming apparatus 10 according to the present exemplary embodiment. The image forming apparatus 10 illustrated in FIG. 1 employs, for example, an electrophotographic scheme to form an image on a recording medium P. The image forming apparatus 10 includes an image forming section 12, a transporting section 14, a feed-transporting section 16, and a fixing device 70. The image forming apparatus 10 further includes a holding unit 100, which is configured to hold a transfer belt 30. The transfer belt 30, to be described below, is included in the image forming section 12. The recording medium P is an exemplary medium.

Now, the feed-transporting section 16, the image forming section 12, the transporting section 14, and the fixing device 70 of the image forming apparatus 10 will be described, followed by description of the holding unit 100.

### Feed-Transporting Section

The feed-transporting section 16 includes a container 61, in which recording media P are contained; and a feeding roll 62, which is configured to feed the recording media P one by one from the container 61. The feed-transporting section 16 further includes a transporting roll (not illustrated) configured to transport each recording medium P fed from the feeding roll 62 to a transferring member 40, which will be described separately below.

### Image Forming Section

As illustrated in FIG. 1, the image forming section 12 has a function of forming toner images (exemplary images) in different colors on a recording medium P. Specifically, the image forming section 12 includes a plurality of toner-image-forming units 80, which are configured to form toner images (exemplary images) in respective colors; a transfer belt 30, which is an exemplary intermediate transfer member; a driving roll 22; a tension applying roll 23; and a counter roll 24. The image forming section 12 further includes a plurality of first-transfer units 77, which are configured to transfer the toner images formed by the respective toner-image-forming units 80 to the transfer belt 30; and a second-transfer unit 31, which is configured to transfer the toner images on the transfer belt 30 to a recording medium P. The toner-image-forming units 80 are each an exemplary image forming unit.

### Transfer Belt

The transfer belt 30 has an endless shape and is stretched over the driving roll 22, the tension applying roll 23, and the counter roll 24 in such a manner as to form an inverted triangle when seen in the front-rear direction. When the driving roll 22 is rotated, the transfer belt 30 moves in such a manner as to rotate in the direction of arrow A. The tension applying roll 23 is configured to apply a tension to the transfer belt 30. The driving roll 22 is located at, for example, a position in the direction of movement of the transfer belt 30 that is on the upstream side relative to the plurality of toner-image-forming units 80 but on the downstream side relative to the counter roll 24. The tension applying roll 23 is located at a position in the direction of movement of the transfer belt 30 that is on the downstream side relative to the toner-image-forming units 80 but on the upstream side relative to the counter roll 24.

### Toner-Image-Forming Units

The plurality of toner-image-forming units 80 are configured to form toner images in respective colors. In the present exemplary embodiment, the toner-image-forming units 80 are provided for four colors of yellow (Y), magenta (M), cyan (C), and black (K). In FIG. 1, characters of Y, M, C, and K representing the respective colors are added as suffixes to the reference number 80 given to the toner-image-forming units.

The toner-image-forming units 80 (80Y, 80M, 80C, and 80K) for the respective colors each include a round columnar photoconductor 82, which is configured to rotate in one direction (represented by arrow E) and is surrounded by, in order from the upstream side in the direction of rotation thereof, a charging device 84, an exposure device 86, and a developing device 88. The photoconductor 82 is an exemplary image carrier.

In each of the toner-image-forming units 80 for the respective colors, the charging device 84 charges the surface of the photoconductor 82, and the exposure device 86 exposes the surface of the photoconductor 82 that has been charged by the charging device 84 to light, whereby an electrostatic latent image is formed on the surface of the photoconductor 82. Furthermore, the developing device 88 develops the electrostatic latent image formed on the surface of the photoconductor 82 by the exposure device 86 into a toner image.

### First-Transfer Units

The first-transfer units 77 include respective first-transfer rolls 78, which are provided on the inner peripheral side of the transfer belt 30 and across the transfer belt 30 from the respective photoconductors 82 included in the toner-image-forming units 80 for the respective colors. In the present exemplary embodiment, the first-transfer rolls 78 are configured to come into contact with the inner peripheral surface of the transfer belt 30. The first-transfer rolls 78 are each an exemplary transfer rotating member. The toner images formed by the toner-image-forming units 80 for the respective colors are sequentially transferred in a first-transfer process to the transfer belt 30 at respective first-transfer positions T1 by the respective first-transfer rolls 78 in such a manner as to be superposed one on top of another. The set of the superposed toner images is then transferred to a recording medium P in a second-transfer process at a second-transfer position T2, which is defined in the second-transfer unit 31.

### Second-Transfer Unit

The second-transfer unit 31 is located on the downstream side relative to the plurality of first-transfer units 77 in the direction of movement of the transfer belt 30. The second-transfer unit 31 includes the transferring member 40. The transferring member 40 is located below the transfer belt 30. The transferring member 40 includes, for example, a transferring body 50, which is positioned such that the axial direction thereof is parallel to the axial direction of the counter roll 24. The transferring body 50 is positioned against the transfer belt 30 such that the transfer belt 30 is nipped between the transferring body 50 and the counter roll 24 to define the second-transfer position T2. When a transfer voltage is applied between the counter roll 24 and the transferring body 50 at the second-transfer position T2, the set of the toner images on the transfer belt 30 is transferred to a recording medium P in the second-transfer process.

In FIG. 1, the direction of transport of the recording medium P is represented by arrow X. A cleaner configured to remove residual toner from the transfer belt 30 may be provided at a position, in the direction of movement of the transfer belt 30, on the downstream side relative to the second-transfer position T2 but on the upstream side relative to the toner-image-forming units 80 (80Y, 80M, 80C, and 80K).

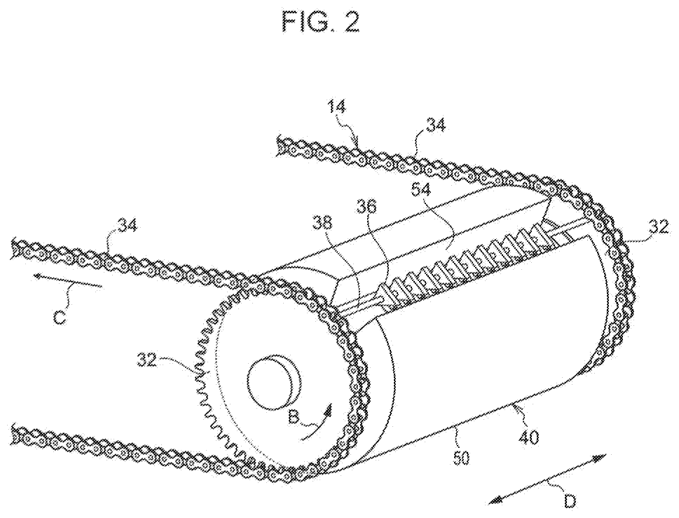

Referring to FIG. 2, the transferring body 50 has in a portion of the outer peripheral surface thereof a recess 54, in which relevant ones of grippers 36 and a relevant one of supporting members 38 are to be positioned. The transferring body 50 is provided at the two axial ends thereof with a pair of sprocket wheels 32. The pair of sprocket wheels 32 are positioned coaxially with the transferring body 50 and are configured to rotate together with the transferring body 50. The transferring body 50 is configured to be rotated by a driving unit (not illustrated). The pair of sprocket wheels 32 support a pair of chains 34, which are wound therearound.

The counter roll 24 is movable by a transfer-process moving mechanism (not illustrated), which includes a cam or the like, between a contacting position where the counter roll 24 is in contact with the transferring body 50 and a retracted position where the counter roll 24 is retracted from the transferring body 50.

### Fixing Device

Referring to FIG. 1, the fixing device 70 is configured to fix the set of the toner images transferred to the recording medium P. Specifically, the fixing device 70 includes a pressing member 42 and a heating roll 72, which are located at a position of the transporting section 14 that is on the downstream side in the direction of transport of the recording medium P.

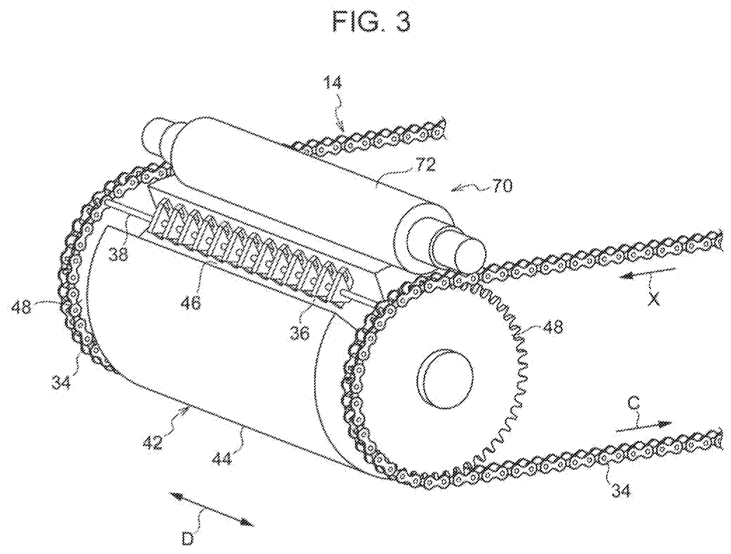

Referring to FIG. 3, the pressing member 42 includes a pressing roll 44, which is positioned such that the axial direction thereof is parallel to the axial direction of the transferring body 50. The pressing roll 44 is provided at the two axial ends thereof with a pair of sprocket wheels 48. The pair of sprocket wheels 48 are positioned coaxially with the pressing roll 44 and are configured to rotate together with the pressing roll 44. The pair of sprocket wheels 48 support the pair of chains 34, which are wound therearound and to be described separately below.

Referring to FIG. 1, the heating roll 72 and the pressing roll 44 are positioned one on top of the other. Specifically, the heating roll 72 is located above the pressing roll 44. The heating roll 72 includes thereinside a heat source 72A, which is a halogen lamp or the like. Hereinafter, the position where the heating roll 72 and the pressing roll 44 nip the recording medium P therebetween is referred to as nipping position NP.

The heating roll 72 is movable by a fixing-process moving mechanism (not illustrated), which includes a cam or the like, between a contacting position where the heating roll 72 is in contact with the pressing roll 44 and a retracted position where the heating roll 72 is retracted from the pressing roll 44. When the heating roll 72 is at the contacting position, the heating roll 72 and the pressing roll 44 are capable of nipping the recording medium P.

The pressing roll 44 has in a portion of the outer peripheral surface thereof a recess 46, in which relevant ones of the grippers 36, to be described below, and a relevant one of the supporting member 38 are to be positioned.

### Transporting Section

Referring to FIGS. 1 to 3, the transporting section 14 has a function of transporting the recording medium P in such a manner as to pass the recording medium P through the second-transfer position T2 and the nipping position NP. The transporting section 14 includes the pair of chains 34 and the grippers 36. The pair of chains 34 are intended to transmit a rotational driving force generated by the transferring body 50 to the pressing roll 44. The grippers 36 are intended to grip the leading end of the recording medium P. The illustration of the chains 34 and the grippers 36 in FIG. 1 is simplified.

As illustrated in FIG. 1, the pair of chains 34 each have an annular shape. As illustrated in FIG. 2, the pair of chains 34 are positioned at an interval therebetween in the depth direction of the image forming apparatus 10 (hereinafter referred to as apparatus-depth direction). The pair of chains 34 are wound around the pair of sprocket wheels 32 coaxially provided on the transferring body 50, and around the pair of sprocket wheels 48 coaxially provided on the pressing roll 44.

When the transferring body 50 is rotated by the driving unit (not illustrated), the pair of sprocket wheels 32 rotate together with the transferring body 50 in a rotating direction B (represented by arrow B), whereby the chains 34 circulate in a circulating direction C (represented by arrow C). Accordingly, the pressing roll 44 rotates by following the chains 34. That is, the pair of chains 34 that circulate in the circulating direction C (see FIG. 1) transmit the rotational driving force generated by the transferring body 50 to the pressing roll 44.

Referring to FIGS. 2 and 3, the pair of chains 34 are provided with the supporting members 38, which are provided with the grippers 36 and each extend in the apparatus-depth direction from one of the chains 34 to the other. The supporting members 38 (three supporting members 38 are provided in the case illustrated in FIG. 1) are fixed to the pair of chains 34 at predetermined intervals in the peripheral direction (circulating direction C) of the chains 34.

Each of the supporting members 38 is provided with a plurality of the grippers 36 that are arranged at predetermined intervals in the apparatus-depth direction. That is, the grippers 36 are attached to the chains 34 with the aid of the supporting members 38. The grippers 36 each have a function of gripping the leading end of the recording medium P.

The grippers 36 include a plurality of catches and a plurality of catch receivers (both not illustrated). The grippers 36 grip the recording medium P such that the leading end of the recording medium P is held between each of the catches and a corresponding one of the catch receivers.

The grippers 36 are to be located on the downstream side relative to the recording medium P in the direction of transport of the recording medium P so as to receive the leading end of the recording medium P from the downstream side in the direction of transport of the recording medium P.

Thus, in the transporting section 14, the leading end of the recording medium P transported from the feed-transporting section 16 is to be gripped by the grippers 36. In the transporting section 14, when the chains 34 are made to circulate in the direction of arrow C with relevant ones of the grippers 36 gripping the leading end of the recording medium P, the grippers 36 gripping the recording medium P move in such a manner as to cause the recording medium P to pass through the second-transfer position T2 together with the grippers 36.

In an area where the chains 34 run along the sprocket wheels 32, relevant ones of the grippers 36 are positioned in the recess 54 provided in the transferring body 50 and move together with the transferring body 50 in the direction of rotation of the transferring body 50. Likewise, in an area where the chains 34 run along the sprocket wheels 48, relevant ones of the grippers 36 are positioned in the recess 46 provided in the pressing roll 44 and move together with the pressing roll 44 in the direction of rotation of the pressing roll 44.

In the transporting section 14, while the heating roll 72 is at the retracted position, the recording medium P is transported to the nipping position NP with the grippers 36 gripping the leading end of the recording medium P. When the recording medium P reaches the nipping position NP in the transporting section 14 and the heating roll 72 is moved to the contacting position, the leading end of the recording medium P is released. Specifically, the transporting section 14 is configured such that the gripping of the leading end of the recording medium P is disabled after the grippers 36 pass through the nipping position NP.

Thus, in the fixing device 70, while the recording medium P nipped between the heating roll 72 and the pressing roll 44 is transported, heat and pressure are applied to the recording medium P, whereby the set of the toner images transferred to the recording medium P is fixed.

### Holding Unit

The holding unit 100 will now be described.

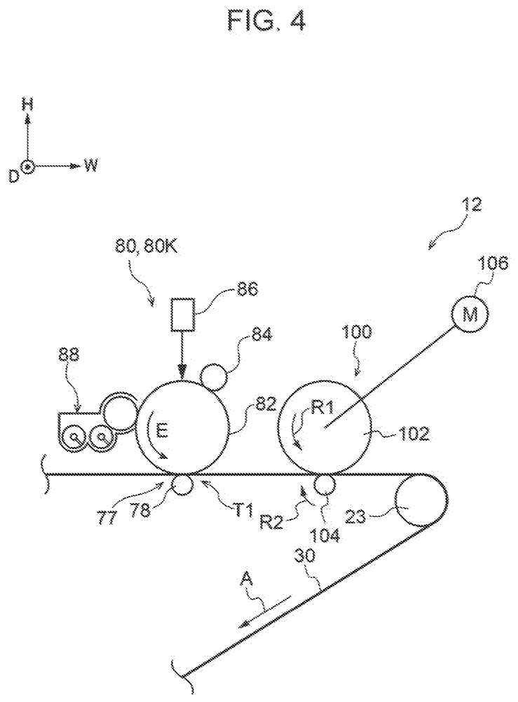

Referring to FIGS. 1 and 4, the holding unit 100 is located, in the direction of movement of the transfer belt 30 (the direction of arrow A), between the downstreammost one of the first-transfer units 77 and the second-transfer unit 31. In an exemplary case, the holding unit 100 is located, in the direction of movement of the transfer belt 30, between the first-transfer unit 77 provided for the downstreammost toner-image-forming unit 80K for black and the tension applying roll 23.

The holding unit 100 is configured to hold the transfer belt 30 from both sides of the transfer belt 30. Specifically, the holding unit 100 includes a first rotatable member 102 and a second rotatable member 104. The first rotatable member 102 and the second rotatable member 104 hold the transfer belt 30 therebetween from the respective sides of the transfer belt 30. The first rotatable member 102 is configured to rotate while being in contact with the outer peripheral surface of the transfer belt 30 to which the toner images are to be transferred from the toner-image-forming units 80. The second rotatable member 104 is pressed against the first rotatable member 102 with the transfer belt 30 in between and is configured to rotate while being in contact with the inner peripheral surface of the transfer belt 30. The holding unit 100 does not have the function of forming a toner image.

The first rotatable member 102 is configured to rotate in a direction (represented by arrow R1) that is the same as the direction of movement of the transfer belt 30 (represented by arrow A) at the point of contact with the transfer belt 30. The second rotatable member 104 is configured to rotate in a direction (represented by arrow R2) that is the same as the direction of movement of the transfer belt 30 at the point of contact with the transfer belt 30. In the present exemplary embodiment, the speed of rotation of the first rotatable member 102 at the point of contact with the transfer belt 30 and the speed of rotation of the second rotatable member 104 at the point of contact with the transfer belt 30 are different from each other. The difference between the speed of rotation of the first rotatable member 102 at the point of contact with the transfer belt 30 and the speed of rotation of the second rotatable member 104 at the point of contact with the transfer belt 30 may preferably be 0.4% or greater but 4% or smaller, more preferably 0.6% or greater but 3% or smaller, much more preferably 0.8% or greater but 2% or smaller.

In an exemplary case, the first rotatable member 102 is connected to a motor 106. The first rotatable member 102 is configured to be rotated by the motor 106 at a speed lower than the speed of movement of the transfer belt 30. In an exemplary case, the second rotatable member 104 is configured to rotate by following the rotation of the transfer belt 30. That is, the speed of rotation of the first rotatable member 102 at the point of contact with the transfer belt 30 is set to a speed lower than the speed of movement of the transfer belt 30. Thus, any slack in the transfer belt 30 is reduced at a position in the direction of movement of the transfer belt 30 that is between the holding unit 100 and the second-transfer position T2.

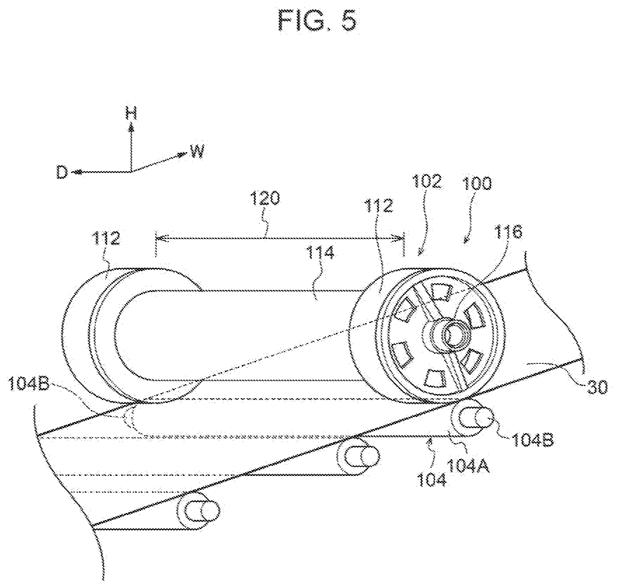

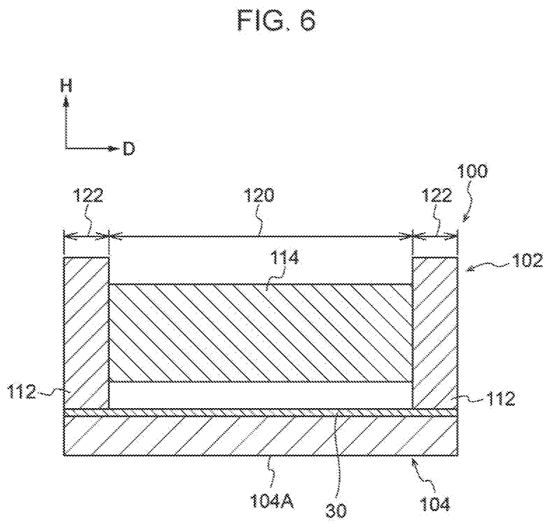

Referring to FIGS. 5 and 6, the first rotatable member 102 cooperates with the second rotatable member 104 in such a manner as to hold no-image areas 122 of the transfer belt 30 where none of the toner images are to be transferred (areas on the respective outer sides relative to an image area 120 in the width direction of the transfer belt 30). Specifically, the first rotatable member 102 includes end portions 112, which are in contact with the respective no-image areas 122 of the transfer belt 30 that are on the two respective sides in the width direction (the direction D) of the transfer belt 30; and a connecting portion 114, which connects the end portions 112 to each other. The end portions 112 and the connecting portion 114 have round shapes, with the outside diameter of the end portions 112 being greater than the outside diameter of the connecting portion 114. The first rotatable member 102 further includes shafts 116, which each extend in the axial direction from a corresponding one of the end portions 112 (see FIG. 5). FIG. 5 illustrates one of the two shafts 116 that is on one side in the axial direction. The shafts 116 are rotatably supported by the housing (not illustrated) of the image forming apparatus 10.

The second rotatable member 104 includes a cylindrical portion 104A, which holds the inner peripheral surface of the transfer belt 30 over the entirety in the width direction; and shafts 104B, which each extend in the axial direction from a corresponding one of the two ends of the cylindrical portion 104A (see FIG. 5). The outside diameter of the cylindrical portion 104A is constant in the axial direction. The shafts 104B are rotatably supported by the housing (not illustrated) of the image forming apparatus 10.

In an exemplary case, the outside diameter of the end portions 112 of the first rotatable member 102 is substantially equal to the outside diameter of the photoconductors 82, and the outside diameter of the cylindrical portion 104A of the second rotatable member 104 is substantially equal to the outside diameter of the first-transfer rolls 78. Herein, the expression “substantially equal to” implies being within the following range. With reference to the outside diameter of the first-transfer rolls 78, the outside diameter of cylindrical portion 104A of the second rotatable member 104 may preferably be within a range of ±10%, more preferably ±5%, much more preferably ±1%.

In an exemplary case, the surface frictional force of the end portions 112 where the first rotatable member 102 is in contact with the transfer belt 30 is greater than the surface frictional force of each of the photoconductors 82. In an exemplary case, the surface frictional force of the cylindrical portion 104A where the second rotatable member 104 is in contact with the transfer belt 30 is greater than the surface frictional force of each of the first-transfer rolls 78. The frictional force is expressed by the following expression:

frictional force=coefficient of friction×frictional drag

For example, the surfaces of the end portions 112 of the first rotatable member 102 or the surface of the cylindrical portion 104A of the second rotatable member 104 may exhibit a greater value for both the coefficient of friction and the frictional drag (nipping load) on the transfer belt 30 than the surface of the photoconductor 82 or the surface of the first transfer roll 78. Alternatively, for example, the surfaces of the end portions 112 of the first rotatable member 102 or the surface of the cylindrical portion 104A of the second rotatable member 104 may exhibit a greater value for one of the coefficient of friction and the frictional drag (nipping load) on the transfer belt 30 than the surface of the photoconductor 82 or the surface of the first transfer roll 78. For example, the surface frictional force of the end portions 112 where the first rotatable member 102 is in contact with the transfer belt 30 may preferably be greater by 30% than the surface frictional force of the photoconductor 82, more preferably greater by 50%, much more preferably greater by 100%. On the other hand, for example, the surface frictional force of the cylindrical portion 104A where the second rotatable member 104 is in contact with the transfer belt 30 may preferably be greater by 30% than the surface frictional force of the first-transfer roll 78, more preferably greater by 50%, much more preferably greater by 100%.

In an exemplary case, the moment of inertia of the first rotatable member 102 is greater than the moment of inertia of the photoconductor 82, and the moment of inertia of the second rotatable member 104 is greater than the moment of inertia of the first-transfer roll 78. The moment of inertia is an index expressing the easiness in moving a rotatable body. Specifically, the moment of inertia is a physical quantity indicating the force with which a rotatable body tends to keep being in the current position, that is, how difficult it is to rotate the rotatable body. The greater the moment of inertia, the greater energy required for acceleration. For example, the moment of inertia of the first rotatable member 102 may preferably be greater by 50% than the moment of inertia of the photoconductor 82, more preferably greater by 100%, much more preferably greater by 200%. On the other hand, for example, the moment of inertia of the second rotatable member 104 may preferably be greater by 50% than the moment of inertia of the first-transfer roll 78, more preferably greater by 100%, much more preferably greater by 200%.

In an exemplary case, the load to be applied to the nip where the transfer belt 30 is nipped by the first rotatable member 102 and the second rotatable member 104 is greater than the load to be applied to the nip where the transfer belt 30 is nipped by the photoconductor 82 and the first-transfer roll 78. Specifically, the load to be applied to the nip where the transfer belt 30 is nipped by the first rotatable member 102 and the second rotatable member 104 may preferably be set to 1.5 or more times the load to be applied to the nip where the transfer belt 30 is nipped by the photoconductor 82 and the first-transfer roll 78, more preferably 2 or more times the latter load, much more preferably 3 or more times the latter load.

### Problems in Image Forming Apparatus According to Comparative Embodiment

Now, problems in an image forming apparatus according to a comparative embodiment will be discussed.

An image forming apparatus according to a comparative embodiment (not illustrated) includes toner-image-forming units that are provided for four respective colors of, in order in the direction of movement of a transfer belt, yellow; magenta; cyan; and black, and from which toner images in the four respective colors are transferred to the transfer belt at respective first-transfer positions in such a manner as to be superposed one on top of another. The set of the toner images superposed on the transfer belt is further transferred to a recording medium P at a second-transfer position. The configuration at each of the first-transfer positions and the configuration at the second-transfer position according to the comparative embodiment are the same as those of the image forming apparatus 10 according to the present exemplary embodiment. The image forming apparatus according to the comparative embodiment includes no holding unit such as the one according to the present exemplary embodiment at a position, in the direction of movement of the transfer belt, between the downstreammost first-transfer position and the second-transfer position.

In the image forming apparatus according to the comparative embodiment, vibrations of the transfer belt that occur at the second-transfer position may be propagated to the first-transfer positions, which are defined on the upstream side in the direction of movement of the transfer belt relative to the second-transfer position. In a large-size image forming apparatus, impulse vibrations occurring at the second-transfer position particularly tend to be greater than in a small-size image forming apparatus, leading to an increase in the vibrations propagated to the transfer belt. Such a vibration fluctuates the position of the image at the first-transfer position defined for one of the plurality of toner-image-forming units that is located at the downstreammost position in the direction of movement of the transfer belt, leading to nonuniformity in the density of the image transferred to the transfer belt.

### Functions of Exemplary Embodiment

Functions provided by the present exemplary embodiment are summarized as follows.

The image forming apparatus 10 includes the plurality of toner-image-forming units 80 configured to form respective toner images in different colors, and the endless-shaped transfer belt 30 that is to move in the peripheral direction thereof. The image forming apparatus 10 further includes the plurality of first-transfer units 77 provided at positions across from the respective toner-image-forming units 80 and configured to transfer the toner images formed by the toner-image-forming units 80 to the transfer belt 30. The image forming apparatus 10 further includes the second-transfer unit 31 provided on the downstream side relative to the plurality of first-transfer units 77 in the direction of movement of the transfer belt 30 and configured to transfer the toner images on the transfer belt 30 to a recording medium P. The image forming apparatus 10 further includes the holding unit 100 provided, in the direction of movement of the transfer belt 30, between the first-transfer unit 77 of the downstreammost toner-image-forming unit 80K and the second-transfer unit 31, the holding unit 100 being configured to hold the transfer belt 30 from both sides of the transfer belt 30.

In the image forming apparatus 10, the holding unit 100 configured to hold the transfer belt 30 from both sides of the transfer belt 30 reduces the propagation of vibrations of the transfer belt 30 that occur in the second-transfer unit 31 to the first-transfer unit 77 located on the upstream side relative to the second-transfer unit 31 in the direction of movement of the transfer belt 30. Specifically, the vibrations of the transfer belt 30 occurring in the second-transfer unit 31 are less likely to be propagated to the first-transfer unit 77 provided for the toner-image-forming unit 80K, which is the downstreammost one of the plurality of toner-image-forming units 80.

The holding unit 100 includes the first rotatable member 102 configured to rotate while being in contact with the outer peripheral surface of the transfer belt 30, the outer peripheral surface receiving the toner images to be transferred from the toner-image-forming units 80; and the second rotatable member 104 pressed against the first rotatable member 102 with the transfer belt 30 in between. The second rotatable member 104 is configured to rotate while being in contact with the inner peripheral surface of the transfer belt 30.

In the holding unit 100, the speed of rotation of the first rotatable member 102 at the point of contact with the transfer belt 30 and the speed of rotation of the second rotatable member 104 at the point of contact with the transfer belt 30 are different from each other. Therefore, in the image forming apparatus 10, the force of holding (gripping) the transfer belt 30 by the first rotatable member 102 and the second rotatable member 104 is greater than in a case where the speed of rotation of the first rotatable member at the point of contact with the transfer belt and the speed of rotation of the second rotatable member at the point of contact with the transfer belt are substantially equal to each other. Thus, the holding unit 100 stops or reduces the propagation of vibrations of the transfer belt 30 occurring in the second-transfer unit 31.

The first rotatable member 102 is configured to be rotated by the motor 106 at a speed lower than the speed of movement of the transfer belt 30, and the second rotatable member 104 is configured to rotate by following the rotation of the transfer belt 30.

The first rotatable member 102 cooperates with the second rotatable member 104 in such a manner as to hold the no-image areas 122 of the transfer belt 30 where none of the toner images are to be transferred (areas on the respective outer sides relative to the image area 120 in the width direction of the transfer belt 30).

The first rotatable member 102 includes the end portions 112 that are in contact with the no-image areas 122 of the transfer belt 30 that are on the two respective sides in the width direction of the transfer belt 30 (the areas on the respective outer sides relative to the image area 120 in the width direction of the transfer belt 30), and the connecting portion 114 that connects the end portions 112 to each other. The second rotatable member 104 includes the cylindrical portion 104A that holds the inner peripheral surface of the transfer belt 30 over the entirety in the width direction of the transfer belt 30.

The outside diameter of the end portions 112 of the first rotatable member 102 is substantially equal to the outside diameter of the photoconductors 82, and the outside diameter of the cylindrical portion 104A of the second rotatable member 104 is substantially equal to the outside diameter of the first-transfer rolls 78.

The surface frictional force of the end portions 112 of the first rotatable member 102 is greater than the surface frictional force of each of the photoconductors 82, and the surface frictional force of the cylindrical portion 104A of the second rotatable member 104 is greater than the surface frictional force of each of the first-transfer rolls 78. Therefore, the force of holding (gripping) the transfer belt 30 by the first rotatable member 102 and the second rotatable member 104 is greater than the force of holding the transfer belt 30 by the photoconductor 82 and the first-transfer roll 78.

The moment of inertia of the first rotatable member 102 is greater than the moment of inertia of each of the photoconductors 82, and the moment of inertia of the second rotatable member 104 is greater than the moment of inertia of each of the first-transfer rolls 78. Therefore, the force of holding (gripping) the transfer belt 30 by the first rotatable member 102 and the second rotatable member 104 is greater than the force of holding the transfer belt 30 by the photoconductor 82 and the first-transfer roll 78.

The load to be applied to the nip between the end portions 112 of the first rotatable member 102 and the cylindrical portion 104A of the second rotatable member 104 is greater than the load to be applied to the nip between each of the photoconductors 82 and a corresponding one of the first-transfer rolls 78. Therefore, the force of holding (gripping) the transfer belt 30 by the first rotatable member 102 and the second rotatable member 104 is greater than the force of holding the transfer belt 30 by the photoconductor 82 and the first-transfer roll 78.

In the image forming apparatus 10, the plurality of toner-image-forming units 80 are the toner-image-forming units 80Y, 80M, 80C, and 80K configured to form respective toner images in the four respective colors of yellow, magenta, cyan, and black that are to be combined into a color image.

### Modifications

The present disclosure is not limited to the above exemplary embodiment. Any design changes may be made to the present disclosure without departing from the essence of the present disclosure.

While the above exemplary embodiment relates to a case where the holding unit 100 is provided, in the direction of movement of the transfer belt 30, between the first-transfer unit 77 for the downstreammost toner-image-forming unit 80K for black and the tension applying roll 23, the present disclosure is not limited to such an embodiment. For example, the holding unit 100 may be provided, in the direction of movement of the transfer belt 30, between the tension applying roll 23 and the second-transfer unit 31.

While the above exemplary embodiment relates to a case where the first rotatable member 102 is driven to rotate, whereas the second rotatable member 104 rotates by following the rotation of the transfer belt 30, the present disclosure is not limited to such an embodiment. For example, both the first rotatable member and the second rotatable member may be driven to rotate. Alternatively, the second rotatable member may be driven to rotate, whereas the first rotatable member may rotate by following the rotation of the transfer belt.

In the above exemplary embodiment, the outside diameters and the shapes of the first rotatable member 102 and the second rotatable member 104 may be changed.

In the above exemplary embodiment, the frictional force to be generated at the point of contact of the first rotatable member 102 with the transfer belt 30 and the frictional force to be generated at the point of contact of the second rotatable member 104 with the transfer belt 30 may be changed.

While the above exemplary embodiment relates to a case where the second-transfer unit 31 includes the transferring body 50, the present disclosure is not limited to such an embodiment. For example, the configuration including the transferring body 50, the chains 34, and the grippers 36 may be replaced with a configuration including a second-transfer roll configured to press the transfer belt against the counter roll. In such a configuration, the recording medium is transported to the nip between the transfer belt and the second-transfer roll, and the toner image on the transfer belt is transferred to the recording medium with the application of a transfer voltage between the counter roll and the second-transfer roll.

While the above exemplary embodiment relates to a case where the toner-image-forming units 80Y, 80M, 80C, and 80K configured to form respective toner images in the four respective colors to be combined into a color image are arranged side by side in the direction of movement of the transfer belt 30, the present disclosure is not limited to such an embodiment. For example, the order of arrangement of the toner-image-forming units 80Y, 80M, 80C, and 80K for the four colors may be changed. Moreover, for example, a special-color toner-image-forming unit configured to form a toner image with a toner having a special color may be added to the toner-image-forming units 80Y, 80M, 80C, and 80K for the four colors. For example, the special-color toner-image-forming unit may be located at the upstreammost position or the downstreammost position in the direction of movement of the transfer belt 30 among the plurality of toner-image-forming units 80. If the special-color toner-image-forming unit is added at the upstreammost position in the direction of movement of the transfer belt 30 among the plurality of toner-image-forming units 80, the holding unit that does not have the function of forming a toner image may be provided on the downstream side relative to the downstreammost toner-image-forming unit. If the special-color toner-image-forming unit is added at the downstreammost position in the direction of movement of the transfer belt 30 among the plurality of toner-image-forming units 80, the holding unit that does not have the function of forming a toner image may be provided on the downstream side relative to the special-color toner-image-forming unit.

While the above exemplary embodiment relates to a case where the toner image taken as an exemplary image is to be formed by dry electrophotography, the image is not limited to such a toner image. For example, the image may be a toner image to be formed by wet electrophotography.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming apparatus comprising:
a plurality of image forming units configured to form respective toner images in different colors;
an endless-shaped intermediate transfer member that is to move in a peripheral direction of the intermediate transfer member and to which the toner images are to be sequentially transferred from the plurality of image forming units;
a plurality of first-transfer units provided across from the respective image forming units and configured to transfer the toner images formed by the image forming units to the intermediate transfer member;
a second-transfer unit provided on a downstream side relative to the plurality of first-transfer units in a direction of movement of the intermediate transfer member and configured to transfer the toner images on the intermediate transfer member to a medium; and
a holding unit provided, in the direction of movement of the intermediate transfer member, between a downstreammost one of the first-transfer units and the second-transfer unit, the holding unit being configured to hold the intermediate transfer member from both sides of the intermediate transfer member.

(((2)))

The image forming apparatus according to (((1))),
wherein the holding unit includes
   a first rotatable member configured to rotate while being in contact with an outer peripheral surface of the intermediate transfer member, the outer peripheral surface receiving the toner images to be transferred from the image forming units; and
   a second rotatable member pressed against the first rotatable member with the intermediate transfer member in between, the second rotatable member being configured to rotate while being in contact with an inner peripheral surface of the intermediate transfer member.

(((3)))

The image forming apparatus according to (((2))),
wherein a speed of rotation of the first rotatable member at a point of contact with the intermediate transfer member and a speed of rotation of the second rotatable member at a point of contact with the intermediate transfer member are different from each other.

(((4)))

The image forming apparatus according to (((3))),
wherein the first rotatable member is configured to be rotated at a speed lower than a speed of movement of the intermediate transfer member, and
wherein the second rotatable member is configured to rotate by following the rotation of the intermediate transfer member.

(((5)))

The image forming apparatus according to any of (((2))) to (((4))),
wherein the first rotatable member cooperates with the second rotatable member in such a manner as to hold a no-image area of the intermediate transfer member, the no-image area being an area where none of the toner images are to be transferred.

(((6)))

The image forming apparatus according to (((5))),
wherein the no-image area is defined on each of two sides of the intermediate transfer member in a width direction of the intermediate transfer member,
wherein the first rotatable member includes end portions that are in contact with the respective no-image areas; and a connecting portion that connects the end portions to each other, and
wherein the second rotatable member includes a cylindrical portion that holds the inner peripheral surface of the intermediate transfer member over an entirety in the width direction of the intermediate transfer member.

(((7)))

The image forming apparatus according to any of (((2))) to (((6))),
wherein the image forming units include respective image carriers by which the toner images are to be carried,
wherein the first-transfer units include respective transfer rotating members that are in contact with the inner peripheral surface of the intermediate transfer member,
wherein an outside diameter of the first rotatable member is substantially equal to an outside diameter of each of the image carriers, and
wherein an outside diameter of the second rotatable member is substantially equal to an outside diameter of each of the transfer rotating members.

(((8)))

The image forming apparatus according to any of (((2))) to (((7))),
wherein the image forming units include respective image carriers that are in contact with the intermediate transfer member and by which the toner images are to be carried,
wherein the first-transfer units include respective transfer rotating members that are in contact with the inner peripheral surface of the intermediate transfer member,
wherein a surface frictional force of the first rotatable member is greater than a surface frictional force of each of the image carriers, and
wherein a surface frictional force of the second rotatable member is greater than a surface frictional force of each of the transfer rotating members.

(((9)))

The image forming apparatus according to any of (((2))) to (((8))),
wherein the image forming units include respective image carriers that are in contact with the intermediate transfer member and by which the toner images are to be carried,
wherein the first-transfer units include respective transfer rotating members that are in contact with the inner peripheral surface of the intermediate transfer member,
wherein a moment of inertia of the first rotatable member is greater than a moment of inertia of each of the image carriers, and
wherein a moment of inertia of the second rotatable member is greater than a moment of inertia of each of the transfer rotating members.

(((10)))

The image forming apparatus according to any of (((2))) to (((9))),
wherein the image forming units include respective image carriers that are in contact with the intermediate transfer member and by which the toner images are to be carried,
wherein the first-transfer units include respective transfer rotating members that are in contact with the inner peripheral surface of the intermediate transfer member, and
wherein a load to be applied to a nip between the first rotatable member and the second rotatable member is greater than a load to be applied to a nip between each of the image carriers and a corresponding one of the transfer rotating members.

What is claimed is:

1. An image forming apparatus comprising:
a plurality of image forming units configured to form respective toner images in different colors;
an endless-shaped intermediate transfer member that is to move in a peripheral direction of the intermediate transfer member and to which the toner images are to be sequentially transferred from the plurality of image forming units;
a plurality of first-transfer units provided across from the respective image forming units and configured to transfer the toner images formed by the image forming units to the intermediate transfer member;
a second-transfer unit provided on a downstream side relative to the plurality of first-transfer units in a direction of movement of the intermediate transfer member and configured to transfer the toner images on the intermediate transfer member to a medium; and
a holding unit provided, in the direction of movement of the intermediate transfer member, between a downstreammost one of the first-transfer units and the second-transfer unit, the holding unit being configured to hold the intermediate transfer member from both sides of the intermediate transfer member.

2. The image forming apparatus according to claim 1,
wherein the holding unit includes
a first rotatable member configured to rotate while being in contact with an outer peripheral surface of the intermediate transfer member, the outer peripheral surface receiving the toner images to be transferred from the image forming units; and
a second rotatable member pressed against the first rotatable member with the intermediate transfer member in between, the second rotatable member being configured to rotate while being in contact with an inner peripheral surface of the intermediate transfer member.

3. The image forming apparatus according to claim 2,
wherein a speed of rotation of the first rotatable member at a point of contact with the intermediate transfer member and a speed of rotation of the second rotatable member at a point of contact with the intermediate transfer member are different from each other.

4. The image forming apparatus according to claim 3,
wherein the first rotatable member is configured to be rotated at a speed lower than a speed of movement of the intermediate transfer member, and
wherein the second rotatable member is configured to rotate by following the rotation of the intermediate transfer member.

5. The image forming apparatus according to claim 2,
wherein the first rotatable member cooperates with the second rotatable member in such a manner as to hold a no-image area of the intermediate transfer member, the no-image area being an area where none of the toner images are to be transferred.

6. The image forming apparatus according to claim 5,
wherein the no-image area is defined on each of two sides of the intermediate transfer member in a width direction of the intermediate transfer member,
wherein the first rotatable member includes end portions that are in contact with the respective no-image areas; and a connecting portion that connects the end portions to each other, and
wherein the second rotatable member includes a cylindrical portion that holds the inner peripheral surface of the intermediate transfer member over an entirety in the width direction of the intermediate transfer member.

7. The image forming apparatus according to claim 2,
wherein the image forming units include respective image carriers by which the toner images are to be carried,
wherein the first-transfer units include respective transfer rotating members that are in contact with the inner peripheral surface of the intermediate transfer member,
wherein an outside diameter of the first rotatable member is substantially equal to an outside diameter of each of the image carriers, and
wherein an outside diameter of the second rotatable member is substantially equal to an outside diameter of each of the transfer rotating members.

8. The image forming apparatus according to claim 2,
wherein the image forming units include respective image carriers that are in contact with the intermediate transfer member and by which the toner images are to be carried,
wherein the first-transfer units include respective transfer rotating members that are in contact with the inner peripheral surface of the intermediate transfer member,
wherein a surface frictional force of the first rotatable member is greater than a surface frictional force of each of the image carriers, and
wherein a surface frictional force of the second rotatable member is greater than a surface frictional force of each of the transfer rotating members.

9. The image forming apparatus according to claim 2,
wherein the image forming units include respective image carriers that are in contact with the intermediate transfer member and by which the toner images are to be carried,
wherein the first-transfer units include respective transfer rotating members that are in contact with the inner peripheral surface of the intermediate transfer member,
wherein a moment of inertia of the first rotatable member is greater than a moment of inertia of each of the image carriers, and
wherein a moment of inertia of the second rotatable member is greater than a moment of inertia of each of the transfer rotating members.

10. The image forming apparatus according to claim 2,
wherein the image forming units include respective image carriers that are in contact with the intermediate transfer member and by which the toner images are to be carried,
wherein the first-transfer units include respective transfer rotating members that are in contact with the inner peripheral surface of the intermediate transfer member, and
wherein a load to be applied to a nip between the first rotatable member and the second rotatable member is greater than a load to be applied to a nip between each of the image carriers and a corresponding one of the transfer rotating members.

11. An image forming apparatus comprising:
a plurality of image forming means for forming respective toner images in different colors;
endless-shaped intermediate transfer means that is to move in a peripheral direction of the intermediate transfer member and for receiving the toner images that are to be sequentially transferred from the plurality of image forming means;
a plurality of first-transfer means provided across from the respective image forming means and for transferring the toner images formed by the image forming means to the intermediate transfer means;
second-transfer means provided on a downstream side relative to the plurality of first-transfer means in a direction of movement of the intermediate transfer means and for transferring the toner images on the intermediate transfer means to a medium; and
holding means provided, in the direction of movement of the intermediate transfer means, between a downstreammost one of the first-transfer means and the second-transfer means, the holding unit being provided for holding the intermediate transfer member from both sides of the intermediate transfer member.
